(19) United States
(12) Patent Application Publication
(10) Pub. No.: US 2002/0103736 A1
(43) Pub. Date: Aug. 1, 2002

(54) Method for secure credit card entry into an online database

(76) Inventor: Steven L. Webb, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/772,755

(22) Filed: Jan. 29, 2001

(51) Int. Cl. G06F 17/60

(52) U.S. Cl. 705/35; 379/93.12

(57) ABSTRACT

A method for more securely entering credit card numbers into online databases.

### FIELD OF THE INVENTION

The present invention relates generally to using credit cards for Internet purchases and more specifically to a method for more securely entering credit card numbers into online databases.

### BACKGROUND OF THE INVENTION

When shopping online, there are a number of methods to make payment for the items that were selected. One way is to enter a credit card number into the web service that the item will be purchased from. This typically involves typing the credit card number onto the computer that is connected to the Internet and sending the credit card number electronically to the web site. Once the credit card number has been sent and entered into the web site, the web site typically saves the number to be used for any future purchases. That way the user does not need to retype the credit card number each time the user makes a purchase from that web site. Unfortunately even with encrypted communication between the user's computer and the web site, some credit card numbers are stolen during this process. Because of the risk of having the credit card number stolen, most web sites have alternative methods for users to pay for their purchases. One alternative method is using the phone. The user selects an item using the web page and then dials a toll free number to make the purchase. Using this method the user gives the credit card number to a person over the phone. Some users feel much more comfortable giving their credit card number out using this method. Unfortunately, when this method is used the credit card number is not entered into the online database. Therefore the user must give the credit card number to the company each time they wish to make a purchase.

There is a need for way to combine the security of giving your credit card number to a person, over the phone, with the convenience of having your credit card number active in an online database.

### SUMMARY OF THE INVENTION

A method for more securely entering credit card numbers into online databases.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a flow chart of the method to more securely entering credit card number into an online databases according to the current invention.

### DETAILED DESCRIPTION OF THE PREFERRED EMBODIMENT

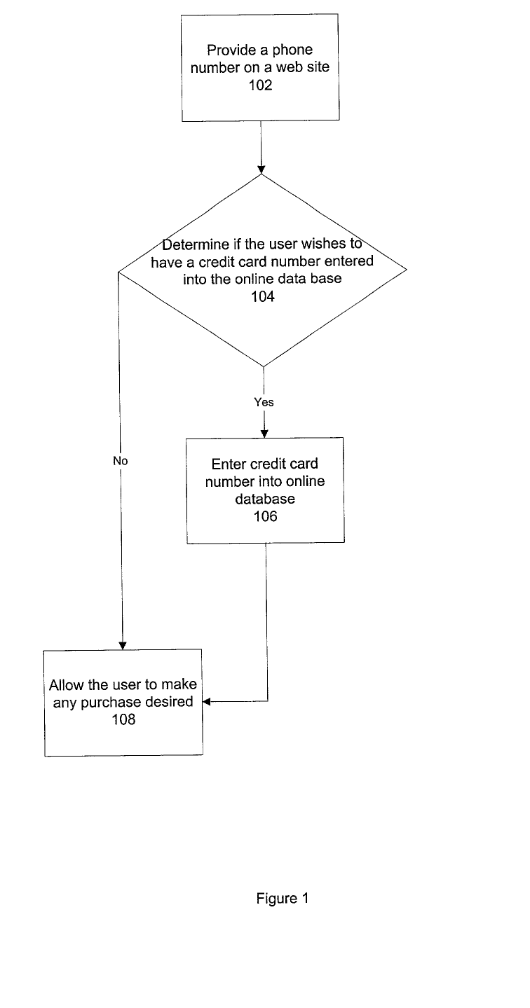

A method that combines the security of giving your credit card number to a person, over the phone, with the convenience of having your credit card number active in an online database, may enhance users online shopping experience. Using this method a web site would provide a phone number on one of their web pages (see FIG. 1). The phone number may be a toll free number. The user can call the number and give their credit card number to the web site. The user may be asked if they would like the credit card number to be entered into the online database (104). The user may also purchase any items they had selected from the web site, using the credit card number (108). Once the web site has the credit card number they may enter the number into an online database using a computer inside their firewall.

A firewall is a device that provides security to networks by preventing unauthorized access from computers outside the firewall to computers inside the firewall. The firewall can be a software device or a hardware device or a combination of hardware and software. Firewalls are well known in the arts. Typically communication between computers in a network that are inside a firewall do not require a high level of protection or encryption. Internet companies typically have their internal computer networks surrounded with a firewall that controls access to their network from external devices. These internal computers typically contain the company's online databases. By surrounding their internal computers with a firewall it prevents external devices from detecting or accessing the communication between computers inside the firewall. Therefore when a person enters a credit card number into a database using a computer that is inside the firewall, it is typically more protected than entering the same number from a computer outside the firewall.

Once the credit card number has been entered into the online database the user can purchase items without having to enter the credit card number.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for entering credit card numbers into an online database, comprising:
providing a phone number on a web page;
accepting a credit card number when a users calls the phone number;
entering the credit card number into an online database thereby enabling the user to use the credit card number, without the user entering the credit card number, the next time the user visits the web page.

2. The method of claim 1 where the credit card number is entered into the online database from the inside of a firewall.

3. The method of claim 1 further comprising the steps:
determining if the user wishes to have the credit card number entered into the online database;
entering credit card number into the online database only when the user wishes the credit card number to be entered.

4. The method of claim 1 further comprising the step:
allowing the user to pay for any purchases with the credit card number while they are on the phone.

5. The method of claim 1 where the phone number is a toll free number.
